(19) United States
(12) Patent Application Publication
(10) Pub. No.: US 2008/0309616 A1
(43) Pub. Date: Dec. 18, 2008

(54) Alertness testing method and apparatus

(76) Inventor: R. Kemp Massengill, (US)

Correspondence Address: GERALD W. SPINKS, 103 EDWARDS STREET, ABBEVILLE, LA, 70510, US

(21) Appl. No.: 12/157,327

(22) Filed: Jun. 9, 2008

Related U.S. Application Data
(60) Provisional application No. 60/934,459, filed on Jun. 13, 2007.
(60) Provisional application No. 60/936,288, filed on Jun. 18, 2007.

(51) Int. Cl. G09G 5/00

(52) U.S. Cl. 345/156

(57) ABSTRACT

A method and apparatus for detecting the alertness of an equipment operator by displaying a moving icon, and asking the operator to track the movements of the icon, either by following it with the eyes in a head mounted display, or by following it with a finger on a touch screen. The operator's performance can be measured by tracking the gaze of the operator's eyes, or by tracking the operator's finger movements. The performance of the operator can be compared to that particular person's history of test results, or to a data base of test results of other operators. The characteristics of the icon can be varied, and distractions can be provided on the display or screen. Control of the display or screen, tracking of the operator's eyes or finger, and analysis of the test results, can all be performed by a computer.

### CROSS REFERENCE TO RELATED APPLICATIONS

This application relies upon U.S. Provisional Patent Application No. 60/934,459, filed on Jun. 13, 2007, and entitled “Alertness Tester Method and Apparatus,” and upon U.S. Provisional Patent Application No. 60/936,288, filed on Jun. 18, 2007, and entitled “Alertness Tester for Detecting Impaired Motorists.”

### STATEMENT REGARDING FEDERALLY SPONSORED RESEARCH OR DEVELOPMENT

Not Applicable

### BACKGROUND OF THE INVENTION

1. Field of the Invention

This invention is in the field of methods and apparatus used in the testing of personnel who engage in a dangerous activity. Examples of such personnel are those who operate equipment, such as automobiles, airplanes, boats, or construction equipment, or personnel with critical occupations, such as surgeons or air traffic controllers.

2. Background Art

Certain occupations require the highest levels of performance, with unwavering concentration, often for long periods of time. Commercial airline pilots, air traffic controllers, surgeons, and long-distance haulers are typical occupations where concentration lapses can result in catastrophic injury. Other pursuits, although more mundane, still present opportunities for injury resulting from lapses in concentration, such as the driving of automobiles. The personnel engaged in any such activity are called herein “operators”, with reference to their engagement in dangerous activities or operations, rather than referring to the actual operation of any particular equipment.

In such activities, not only may the operator's own life be at risk, but also at risk are the surgeon's patient, the pilot's passengers, or even simple bystanders. The operator should not be allowed to engage in any such activity when a dangerous lack of alertness is noted, such as from extreme fatigue, from acute substance abuse, or even from neurological deficit, as operator error is much more likely to occur.

Surgeons and air traffic controllers often work with so little time off between shifts that sleep deprivation is quite common. Yet, regardless of being fatigued, sometimes to the point of exhaustion, decisions must be made by such an operator. When a staff shortfall occurs, or even chronically in some cases, such an operator is frequently compelled to work overtime. An overworked operator who reports for duty while already in an acutely fatigued or intoxicated state constitutes a dangerous threat to the lives of other people.

Operating a motor vehicle, such as an automobile, requires a high level of performance with unwavering concentration. This is especially true when driving at freeway speeds in congested traffic. Poor roadway conditions, such as from rain or sleet, make driving even more hazardous.

It is estimated that over 50% of motor vehicle accident fatalities involve alcohol, which is well known to cause concentration lapses and errors in judgment. Fatalities can also involve other drugs, with or without alcohol. Many fatalities are innocent victims, such as those run down by drunk drivers or killed in head-on collisions. Unfortunately, attempts to get drunk drivers off the road have been only partially successful.

It is well known that alcohol or other drugs exacerbate, or even cause, a fatigued state characterized by an inability to concentrate properly, with faulty decision making being the norm. When an operator intends to engage in a dangerous activity while fatigued, and, in addition, intoxicated, there is the very real potential for injuries to occur.

When testing a motorist suspected of driving in an impaired condition, a police officer will often have the motorist attempt to walk a straight line with arms extended, or to follow the officer's finger with the eyes while holding the head steady, or to perform a series of simple calculations. These are subjective tests, relying on the interpretation of the officer at the scene. Sometimes the operator becomes annoyed and agitated, and this makes testing even more subjective.

Blood alcohol levels are estimated by a breath analyzer test. While being helpful as an indirect measure of a motorist's ability to perform, the breath analyzer does not measure actual performance and is therefore subjective regarding performance. It is assumed that a person with a high blood alcohol level is impaired, but to what degree is uncertain, as individuals vary regarding alcohol tolerance. Furthermore, blood alcohol levels are completely normal if a person's performance is drug-impaired from a drug other than alcohol.

Routine driver's license examinations currently provide visual acuity testing. However, this testing may not be adequate for subjects who have a disease affecting their vision or their neurological system. An inability to visually track a moving object, for instance, is a sign that this subject may have difficulties operating a motor vehicle in a safe fashion. Currently, this ability is only tested subjectively, and only rarely, during the performance of a driving test accompanied by an official. Certain diseases, such as glaucoma and a cerebrovascular accident (“stroke”), can damage or even obliterate a portion of the visual field. Although the subject may be “mentally alert”, he or she may not be “actually alert” to a dangerous situation, because of this degradation of the visual field. This damage to the peripheral visual field can be present, even if a subject sees at the level of 20/20 on a Snellen chart, which measures only central visual acuity. Such an operator would easily pass the visual acuity portion of the driver's license test requirement. Yet, this subject can have severely diminished alertness to even a large object (such as on oncoming truck) in an area of significant visual field loss.

While it is true that patients with neurological problems can sometimes drive with proper care and concern for their safety and that of others, this is by no means universally the situation. In fact, a driver's license is often given to people who are incapacitated to one degree or another, but who pass the visual aspects of a driver's license exam. Compounding the problem is that patients can withhold vital medical information, and those with subtle neurological and/or visual deficits sometimes do exactly this to keep driving. There is no presently known alertness screening test in use as part of the routine examination of persons seeking a driver's license, or a driver's license renewal.

Therefore, a reliable alertness test is necessary which objectively assesses and documents the performance level of an operator engaging in a dangerous activity, ideally before that person begins the activity.

### BRIEF SUMMARY OF THE INVENTION

The present invention is a method and apparatus for objective testing of alertness in subjects engaged in dangerous activities, such as airline pilots, air traffic controllers, or motorists, where a lack of alertness can result in injury. The test is ideally performed prior to the operator engaging in such activity, and a performance score is given. Operators engaged in critical professions, such as air traffic controllers, can be tested before each shift, to determine their alertness on a specific occasion. Operators frequently engaging in dangerous activities, such as motorists, can be tested as a part of a licensing examination, to determine their general fitness to engage in the activity. Additionally, an operator can be tested if he or she is suspected of not being sufficiently alert on a specific occasion, such as with a suspected intoxicated driver. So, the test can be used to determine whether an operator lacks the required level of alertness, either acutely or chronically. The test can be performed with a computer-controlled head mounted display and gaze tracking apparatus, or, alternatively, it can be performed with the use of a computer with an interactive screen.

An icon is displayed for viewing by the operator being tested, either in a head mounted display or on an interactive computer screen, such as a touch screen. The operator is instructed to follow the movements of the icon as closely and quickly as possible. The icon is then moved from one location to another on the display, and the operator's performance at following the icon is measured. Both the quickness with which the operator responds and the accuracy of that response can be measured. The icon can be shown in one location, followed by disappearance of the icon and its appearance at a second location, repetitively moving to a plurality of different discrete locations on the display. In this mode, the operator tracks the successive discrete locations of the icon as quickly and accurately as possible. Alternatively, the icon can be continuously displayed, and moved around the display, and the operator continuously tracks the location of the icon. With the head mounted display embodiment, the operator simply follows the icon with his or her eyes, and the operator's performance is detected by a gaze tracking device in the head mounted display. With the touch screen embodiment, the operator follows the movement of the icon by touching his or her finger to the screen, at the location of the icon. In the touch screen embodiment, the screen can be touched with the finger in discrete locations or in a continuous movement of the finger around the screen. Touch screens of both types are well known in the art.

The performance of the operator is compared with a baseline of data obtained in one of two ways. The baseline data can be data obtained by previous test performances by the same operator, thereby comparing the operator's alertness on a given day with his or her normal level of alertness. This method might be appropriate, for example, for pre-flight alertness testing of an airline pilot. Or, the baseline data can be data obtained by test performances by different operators, thereby comparing this particular operator's alertness with the alertness levels of a class of operators. This method might be appropriate either for such uses as pre-flight alertness testing of a pilot or testing of an apparently intoxicated motorist, or for such uses as determining whether a motorist should be licensed to drive.

Testing equipment can be located in remote areas and linked to a central computer over the Internet, with the central computer performing all icon movements, detection and analyses of tracking performance, and comparison with baseline data.

The novel features of this invention, as well as the invention itself, will be best understood from the attached drawings, taken along with the following description, in which similar reference characters refer to similar parts, and in which:

### BRIEF DESCRIPTION OF THE SEVERAL VIEWS OF THE DRAWINGS

FIG. 1 is a schematic of a goggle type head mounted display;

FIG. 2 is a schematic of a table top type head mounted display;

FIG. 3 is a schematic of a system according to the present invention;

FIG. 4 is a schematic showing performance of the method according to the present invention on a touch screen display;

FIG. 5 shows various icon movement paths that may be employed with the present invention;

FIG. 6 illustrates the use of distraction icons with the present invention; and

FIG. 7 shows the concepts of the various baseline data bases.

### DETAILED DESCRIPTION OF THE INVENTION

The present invention measures alertness objectively, via a test protocol which can be individualized by comparing the most recent test results of an operator against a pre-established baseline for that particular operator. Or, the test performance of the operator can also be objectively measured against pre-determined standards considered essential for safe performance in his or her chosen activity.

The images presented to the test subject are designed for the test subject to follow with his or her eyes. The images thus presented, and to which the test subject's attention is directed, are designated as the “fixation icon.” The alertness test can employ either a computer-controlled head mounted display as defined herein, fitted with a gaze tracking device, or a computer with an interactive touch screen. In the former embodiment, the operator simply follows a moving icon with his or her eyes. In the latter embodiment, the operator uses finger movements to track the moving icon which appears on the screen. In both embodiments, means is provided for computer control of the test protocols, including the movement or relocation of the fixation icon, and for computerized analyses of the test results. Software can compare the performance of the person being tested with baseline tests performed previously on the same subject, such as on a different day when the tested subject was completely alert. This establishes a “Personal Baseline Profile.” The individual's performance can also be compared with experimentally established baseline performance standards for safety for the given industry or activity. This establishes an “Industry Baseline Profile.”

Expert systems, including but not limited to neural nets, can be employed to look for subtle degradations in real-time performance. Although these subtle degradations in performance in and of themselves may appear individually benign, when examined cumulatively over the length of the test, these can be a sign that the test subject's ability to perform critical tasks is at an inadequate level. Performance standards can be developed to prevent test subjects from working if their score is below a minimum threshold which is considered safe. An inadequate performance score on the alertness test of the present invention, then, should preclude that operator from engaging in a critical activity on that day, thereby safeguarding the lives of those depending upon the critical performance of the test subject. Alternatively, such as during the motorist licensing procedure, an inadequate performance level can preclude licensing of that operator.

These standards can be determined experimentally, either by repetitive testing of a given operator, or by having a statistically appropriate number of subjects engaged in the given activity perform the test. Differences in performance between the baseline and the subsequent test are graded by the computer software, and a numerical score is provided, such as 6 on a scale of 10, or 4 on a scale of 10.

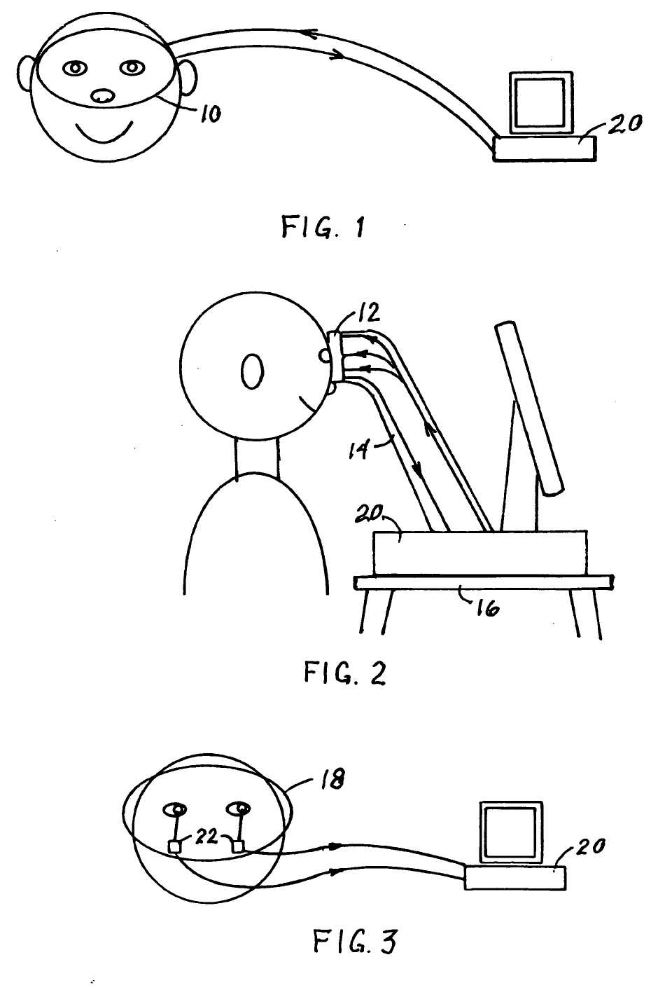

For the purposes of this application, a “head mounted display” is defined as a display device which remains in a fixed relationship with the head of the operator being tested. A first type of head mounted display is illustrated in FIG. 1. The display can be presented in any headgear 10, such as goggles or glasses or other suitable eyepieces worn by the subject, said head mounted display moving along with the head as the subject moves his or her head. The headgear 10 is connected to a computer 20 which controls the display and movement of a fixation icon, and which senses the gaze direction of the test subject's eyes, as discussed below. Alternatively, as shown in FIG. 2, a “head mounted display” can include an embodiment in which the head mounted display apparatus 12, such as goggles, glasses, or other suitable eyepieces, is placed in a structure 14 that is fixed in position, and connected to a computer 20. The apparatus 12 can be placed on any stable structure, such as on a table 16, a counter, or an independent stand. In this type of head mounted display, the subject's head must not move significantly, relative to the display apparatus 12. This table-top type of head mounted display can have orientation adjustments to allow its comfortable alignment with the test subject's head. Both of these types of head mounted displays employ the use of a gaze tracker to observe the operator's eye movements, to determine how closely the test subject's gaze is fixed on the fixation icon.

The operation of the system, including presenting the fixation icon and directing its movement, supplying distraction images such as additional icons, data collection, and data analyses are controlled by a suitable computer with custom software programs. If necessary, the refractive error of the subject can be compensated with appropriate lenses. The test subject is presented with visual images produced by the appropriate micro-display devices compatible with a head mounted display system, such as OLED displays, LCD displays, LED displays, retinal displays, etc. The present invention does not limit the display device used, as long as it is functionally operative with a head mounted display system.

One possible display system is the Z800 3D Visor (from eMagin, Bellevue, Wash.), which uses a pair of eMagin SVGA OLED (organic light-emitting diode) micro-displays. These deliver high-speed, high-resolution (800×600 triad pixels), high-color (>16 million) images. OLED micro-displays are thinner and lighter than Liquid Crystal Displays (LCDs) and have higher luminance. The field of view is about 40 degrees (diagonal), corresponding to 32 and 24 degrees in the horizontal and vertical directions, respectively. The Z800 3DVisor is compatible with PCs that are capable of producing an analog SVGA resolution (800×600) with a refresh rate of 60 Hz. The Z800 was specifically designed to accommodate most forms of refractive eyewear.

A representative diagram of the present invention in a head mounted display configuration is shown in FIG. 3. The apparatus can employ a head mounted, virtual reality display 18. The display can be a three dimensional stereovision display. The instantaneous gaze direction is measured via gaze trackers 22, which follow the movement of the subject's pupils (or other suitable gaze-tracking parameters) with high time resolution (typically 30 to 60 measurements per second). Thus, the gaze direction is followed in real time, measuring the detailed response to the dynamically varying fixation icon described herein. High quality gaze trackers allow subtle eye movements to be tracked, an important consideration in measuring alertness states.

As shown in FIG. 3, the head mounted display can employ two gaze-tracking devices 22 (typically consisting of a camera and infra-red illuminator) which are mounted, preferably at the bottom of the display 18. The position of the gaze tracker 22 with respect to the eye may be adjusted in the horizontal direction (linear motion) and in the vertical direction (rotation). The test subject's eyes are monitored with the gaze trackers, and erratic movements are processed by the computer 20. A permanent record is established. Eye movement “overshoots” and “undershoots” are of particular interest, as these indicate performance degradation, such as from fatigue or from intoxication, or both. The use of gaze tracking provides accurate correlation of the subject's ability to visually follow the fixation icon. This is critical for objectivity, as it removes the subjective component related to an observer simply watching the eyes of the person being tested.

An alternative embodiment is to employ a gaze tracker 22 for only one eye. Tracking only one eye relies on the fact that, in normal persons, eye movements of one eye correlate with eye movements of the fellow eye, i.e., the eyes move together.

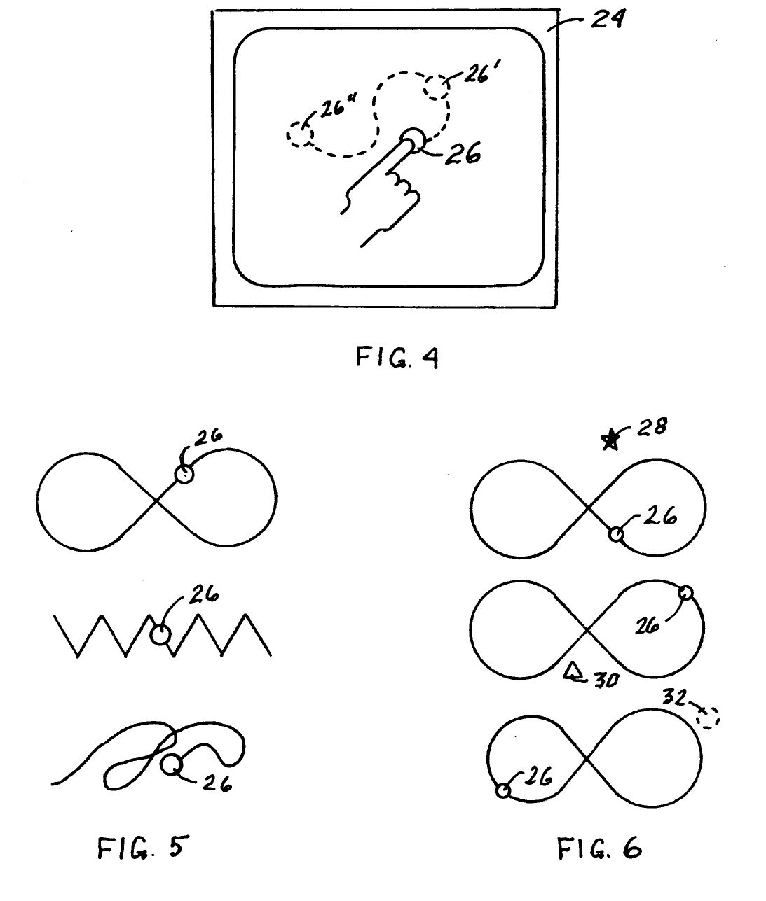

A further alternative embodiment, as shown in FIG. 4, uses a computer with an interactive touch screen 24, the fixation icon 26 described herein being presented on the computer monitor touch screen 24. The test subject, wearing appropriate eyewear to compensate for any refractive error, then manually tracks the fixation icon 26 with his or her finger. The touch screen 24 detects the patient's finger movements, and the software of the system compares these with the actual movement of the fixation icon 26. Movement of the fixation icon 26 is represented by the dashed line in FIG. 4.

Regardless of whether the head mounted display or the touch screen display is used, the fixation icon 26 can be continuously displayed along this path of movement. Alternatively, the fixation icon can be sequentially displayed at a series of discreet locations as represented by the circles 26, 26′, 26″ in FIG. 4. The disappearance of the fixation icon 26 at one location can be followed instantaneously by the reappearance of the icon 26 at another location, such as at 26′ or 26″. Alternatively, there can be a lag time between the disappearance of the fixation icon 26 at one location and the reappearance of the icon 26 at another location. Deviations, such as faulty tracking, overshoots, and undershoots between the fixation icon movement and the subject's eye or finger movements indicate a lack of alertness, such as from fatigue or intoxication. Where the icon 26 is sequentially displayed in a plurality of discrete locations, the test subject's tracking of the icon is by a sequential series of eye fixations or screen touches at the sequential locations where the icon 26 appears. Where the icon 26 is continuously displayed, the test subject tracks the position of the icon 26 continuously as it moves around the display 24.

The fixation icon can be presented to the test subject in black and white, such as a black icon against a white background, or the reverse, or in chosen colors, with one example being red on green, or green on red, and another being yellow on blue, or blue on yellow. The fixation icon, as directed by the computer, can move at a constant speed, or at varying speeds, and can also be directed to halt movement altogether at any designated time. The fixation icon can dynamically vary in size and shape. As shown in FIG. 5, the fixation icon 26 can travel in many different patterns, including a “figure-of-eight” pattern, in a “w” pattern, in any other pattern, or randomly, i.e., the present invention does not contemplate limits on the motion, the speed, or the dynamic variation of the fixation icon 26.

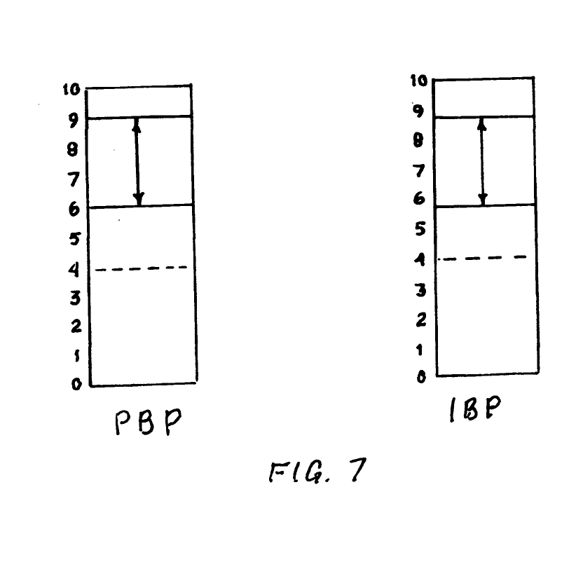

The test subject is told to constantly track the appropriate icon 26 regardless of its motion or lack of motion, or speed of motion. For instance, the icon 26 may move to the left, to the right, diagonally, or randomly, and at a constant speed, or at different speeds. If using a stereo head mounted display, the icon 26 may appear to the test subject to come closer or go further away. The icon 26 may also become harder to visualize, because the intensity of either the icon itself or the background may change. Additionally, “distraction” icons, as shown in FIG. 6, may be presented to test how well the test subject maintains concentration when presented with visual confusion. For example, as shown in the first view of FIG. 6, where the fixation icon 26 is a solid circle traveling in a “figure eight”, distraction icons can be presented as a star 28, a triangle 30, or a dashed or flashing circle 32. Any other type of distraction icon may also be used. Distracting sounds of various sorts can also be presented to the test subject via earphones or external speakers. These sounds can be used as part of a “confusion” environment designed to test the subject's ability to concentrate on the task at hand. Subjects who are fatigued and/or intoxicated have much greater difficulty following the fixation icon 26 if confusing elements, both visual and auditory, are presented.

The speed of the moving icon is very important as an alertness measurement. Intoxicated and/or fatigued subjects have a difficult time following a fast-moving target, especially if that target changes direction quickly. As an example, if a fixation icon is moving to the left and then suddenly and without warning moves back to the right, a subject with an alertness deficit tends to keep looking to the left and will temporarily lose fixation of the icon, since it has now moved to the right. The subject then begins to search for the fixation icon.

All of these eye movements (or finger movements when using the computer touch-screen embodiment), and the cohesiveness and the smoothness noted, are recorded onto the computer for analyses. Of course, even a completely rested “high-performance” individual will make a certain number of tracking mistakes. What is important is how many mistakes are made, whether these are subtle or gross, and the frequency with which they occur. This information enters the computer, where it is analyzed and compared with the baseline data. This baseline data can include pre-established background data for the specific operator being tested, or the typical performances of other individuals who engage in the same activity.

Deviations related to inability of the test subject to properly track the fixation icon are analyzed by the computer software and compared with the Personal Baseline Profile PBP of the subject in question, and, in addition or in the alternative, these deviations can be compared with the Industry Baseline Profile IBP, both of which are conceptually illustrated in FIG. 7. The Personal Baseline Profile is established by comparing the performance of the person being tested with baseline tests performed previously on the same person, such as on different days when the tested subject was completely alert. The Industry Baseline Profile is established by collecting and analyzing the performances of a statistically significant number of persons engaged in the activity in question. For example, for pilot testing, the Industry Baseline Profile might be established by testing airline pilots. For driver testing, the Industry Baseline Profile might be established by testing drivers of automobiles.

Faulty performance demonstrating a significant alertness deficit should result in preventing the operator from engaging in critical activity for the day in question. Although the ability to visually track a given fixation icon tends to vary from person to person, for an individual subject, the test results tend to be quite similar for a particular state of alertness. When a number of test results have been obtained for a particular operator during a state of alertness, this composite profile constitutes that subject's Personal Baseline Profile. When the subject is intoxicated and/or severely fatigued, however, the test results are degraded relative to the subject's Personal Baseline Profile (as well as the Industry Baseline Profile).

The following example shows one way the method and apparatus of the present invention can be employed. Assume that a commercial airline pilot reports to work. That pilot's Personal Baseline Profile alertness database, as shown in FIG. 7, has been established in advance. Assume that the pilot's normal performance level on the test is in the range of 6 to 9 on a scale of 10, as shown by the range between the solid horizontal lines in this particular pilot's Personal Baseline Profile in FIG. 7. Also assume that the normal performance level of all airline pilots on the test is 5.75 to 8.75 on a scale of 10, as shown by the range between the solid horizontal lines in the Industry Baseline Profile, in FIG. 7. If a deficit is noted on a particular day, as compared with the pilot's Personal Baseline Profile, or as compared with the Industry Baseline Profile, it is advisable that the subject pilot not be allowed to fly. Assume that on the given day, the pilot scores a 4, as shown by the horizontal dashed lines in FIG. 7. This score is well below the pilot's Personal Baseline Profile range of 6 to 9, and it is well below the Industry Baseline Profile range of 5.75 to 8.75. The pilot should probably be grounded on this day. Of course, if a pilot is frequently in a “lack of alertness” state, as documented by comparing the Personal Baseline Profile to the Industry Baseline Profile, and by noting chronic deficiencies, the pilot should not be licensed to fly. As with all of the examples given here, the actions to be taken as a result of the achievement of a given score should be established by the authorities who are responsible for the particular type of activity in which the operator is engaged.

The following is a further example of how the method and apparatus of the present invention can be employed. Assume that a motorist operating an automobile is pulled over to the side of the road by a policeman suspecting the motor vehicle operator is driving under the influence. In this case, a Personal Baseline Profile will not likely be available for this particular operator. However, the driver's performance can be compared with an Industry Baseline Profile for motorists in general, which can be obtained by testing a statistically significant number of motorists who are sober. A breath analyzer test is performed on the motorist, which indicates, for instance, a blood alcohol level of twice normal. The motorist then takes the performance test of the present invention, using a computer with either an interactive touch screen or a head mounted display. Assume that the motorist scores 3, which is well below the pre-established motor vehicle safety Industry Baseline Profile for automobile drivers, which let us say is 6 to 9. This individual is significantly performance impaired, and this performance impairment has now been objectively tested and objectively recorded on the computer.

A third example of how the method and apparatus of the present invention can be employed, is in the field of examination of persons who are applying for a driver's license. In this case, again, there will not be a Personal Baseline Profile of data for a given applicant. However, the test can be administered to the applicant, using either the head mounted display or the touch screen display. The applicant's performance level can then be compared to a pre-established motor vehicle safety Industry Baseline Profile for automobile drivers who have good driving records. Assume that the Industry Baseline Profile range is between 5 and 8. If the applicant scores a 4, this might indicate that the applicant must pass a driving test accompanied by an examiner before being licensed. If the applicant scores a 2, this might indicate that the applicant should be rejected without further testing.

In each of these examples, the overall “alertness” of the operator is being tested. In addition to lack of ability to concentrate on the task at hand, any lack of overall alertness that is detected may derive from intoxication, chronic vision problems, lack of physical coordination, or even a chronic deficit in the operator's mental acuity. However, the test administered according to the present invention is intentionally oriented toward measuring a level of overall performance. This is entirely appropriate, because a reduced level of performance on the test, whatever the underlying cause, can indicate a likelihood of a reduced level of performance in the activity in which the operator plans to engage.

While the particular invention as herein shown and disclosed in detail is fully capable of obtaining the objects and providing the advantages hereinbefore stated, it is to be understood that this disclosure is merely illustrative of the presently preferred embodiments of the invention and that no limitations are intended other than as described in the appended claims.

I claim:

1. A method for testing the alertness of an equipment operator, comprising:
displaying an icon, on a computerized display, in the visual field of an equipment operator;
moving said icon under control of said computer, as said operator attempts to track said movements of said icon;
detecting, with said computer, said operator's attempted tracking of said icon;
analyzing, with said computer, said operator's performance at tracking said icon;
comparing said operator's tracking performance with a performance data base, using said computer; and
determining, with said computer, whether said operator's tracking performance indicates a desired level of alertness, based on said comparison with said performance data base.

2. The method recited in claim 1, wherein:
said icon is displayed as a gaze fixation icon in a head mounted display;
said operator attempts to track said movements of said icon by attempting to maintain said operator's gaze fixed on said moving icon; and
said operator's attempted tracking of said icon is detected by tracking said operator's gaze direction with a gaze tracking device in said head mounted display.

3. The method recited in claim 2, further comprising:
displaying said icon at a plurality of discreet locations on said display; and
detecting said operator's gaze direction corresponding to each of said plurality of locations of said icon.

4. The method recited in claim 3, further comprising:
removing said icon from said display between displays of said icon at said plurality of discreet locations; and
measuring the elapsed time between each reappearance of said icon and fixation of said operator's gaze on said icon after each said reappearance.

5. The method recited in claim 2, further comprising:
continuously displaying said icon as it moves around said display; and
continuously detecting said operator's gaze direction as said gaze direction moves around said display.

6. The method recited in claim 1, wherein:
said icon is displayed on a computer touch screen;
said operator attempts to track said movements of said icon by attempting to touch said operator's finger to said icon on said touch screen; and
said operator's attempted tracking of said icon is detected by detecting the location of said operator's finger touching said touch screen.

7. The method recited in claim 6, further comprising:
displaying said icon at a plurality of discreet locations on said touch screen; and
detecting said location of said operator's finger corresponding to each of said plurality of locations of said icon.

8. The method recited in claim 7, further comprising:
removing said icon from said touch screen between displays of said icon at said plurality of discreet locations; and
measuring the elapsed time between each reappearance of said icon and touching of said operator's finger on said icon after each said reappearance.

9. The method recited in claim 6, further comprising:
continuously displaying said icon as it moves around said touch screen; and
continuously detecting said location of said operator's finger as said finger moves around said touch screen.

10. The method recited in claim 1, further comprising presenting at least one distraction to said operator.

11. The method recited in claim 10, wherein said at least one distraction comprises at least one auditory distraction.

12. The method recited in claim 10, wherein said at least one distraction comprises at least one visual distraction presented on said computerized display.

13. The method recited in claim 12, wherein said at least one visual distraction comprises alteration of a background on said computerized display.

14. The method recited in claim 12, wherein said at least one visual distraction comprises alteration of said icon.

15. The method recited in claim 12, wherein said at least one visual distraction comprises at least one additional image presented on said computerized display.

16. The method recited in claim 1, further comprising measuring how quickly said operator tracks said icon.

17. The method recited in claim 16, further comprising:
removing said icon from said display between displays of said icon at a plurality of discreet locations; and
measuring the elapsed time between each reappearance of said icon and said operator's tracking of said icon after each said reappearance.

18. The method recited in claim 1, further comprising measuring how closely said operator tracks said icon.

19. The method recited in claim 1, further comprising comparing said operator's tracking performance with past tracking performance data generated by said operator.

20. The method recited in claim 1, further comprising comparing said operator's tracking performance with tracking performance data generated by other operators.

21. An apparatus for testing the alertness of an equipment operator, comprising:
a computerized display adapted to display an icon in the visual field of an equipment operator;
a computer adapted to move said icon around said display;
a means for detecting said operator's attempted tracking of movements of said icon;
a data base of icon tracking performance data;
said computer being programmed to:
analyze said operator's performance at tracking said icon;
compare said operator's tracking performance with said performance data base; and
determine whether said operator's tracking performance indicates a desired level of alertness.

22. The apparatus recited in claim 21, further comprising:
a head mounted display adapted for displaying said icon as a gaze fixation icon;
a gaze tracking device in said head mounted display, said gaze tracking device adapted for detecting said operator's attempted tracking of said icon by tracking said operator's gaze direction.

23. The apparatus recited in claim 21, further comprising a computer touch screen adapted for displaying said icon and detecting said operator's attempted tracking of said icon by detecting the location of said operator's finger touching said touch screen.

24. The apparatus recited in claim 21, further comprising data, in said performance data base, on past performances of said operator at tracking said icon.

25. The apparatus recited in claim 21, further comprising data, in said performance data base, on performances of other operators at tracking said icon.
